(19) United States
(12) Patent Application Publication
(10) Pub. No.: US 2026/0103572 A1
(43) Pub. Date: Apr. 16, 2026

(54) METHODS FOR PREPARING ELASTOMER COMPOSITES WITH MIXER VENTILATION

(71) Applicant: Cabot Corporation, Boston, MA (US)

(72) Inventors: Martin C. Green, Boxborough, MA (US); Carlos Andres Echavarria Yepes, Chelmsford, MA (US); Hodaka Miura, Takasago-shi (JP); Quentin Hartley, Hudson, OH (US); David P. Cacciola, Woburn, MA (US)

(21) Appl. No.: 19/358,099

(22) Filed: Oct. 14, 2025

Related U.S. Application Data
(60) Provisional application No. 63/707,346, filed on Oct. 15, 2024.

(51) Int. Cl. C08J 3/20; B01F 23/53; B01F 27/702; B01F 35/00; B01F 35/21; B01F 35/221; B01F 35/71; B01F 101/00; C08J 3/205

(52) U.S. Cl. CPC C08J 3/203; B01F 23/53; B01F 27/702; B01F 35/187; B01F 35/189; B01F 35/2113; B01F 35/2211; B01F 35/71731; C08J 3/2053; B01F 2101/2805; B01F 2215/045; C08J 2307/00; C08J 2409/00

(57) ABSTRACT

Disclosed herein are methods for preparing an elastomer composite including charging a mixing chamber with at least a solid elastomer and a filler through a ram enclosure and mixing the solid elastomer and the filler in the mixing chamber. The mixing includes moving a ram through a ram space towards the mixing chamber to push the elastomer and the filler in the ram enclosure downwards into the mixing chamber. The mixing further includes directing a flow of gas through the ram space from a vent inlet to a vent outlet disposed in the ram enclosure, the flow of gas passing through the ram space and entraining at least a portion of a vapor resulting from the mixing, and discharging the elastomer composite from the mixing chamber.

### FIELD OF THE INVENTION

This disclosure relates generally to methods for preparing elastomer composites. More specifically, this disclosure relates to methods for providing ventilation in a mixer that prepares or processes elastomer composite.

### BACKGROUND

Numerous products can be formed using elastomeric compositions in which reinforcing filler material is dispersed in any of various synthetic elastomers, natural rubber or elastomer blends. Carbon black and silica, for example, are widely used to reinforce natural rubber and other elastomers. It is common to produce a masterbatch or resulting composite comprising reinforcing material, elastomer, and/or various optional additives, such as rubber chemicals, e.g., in a batch mixer. Such masterbatches are then compounded with processing and curing additives and upon curing, generate numerous products, during downstream or later processing step(s). Such products include, for example, pneumatic and non-pneumatic or solid tires for vehicles, including the tread portion including cap and base, undertread, inner liner, sidewall, wire skim, carcass and others. Other products include, for example, engine mounts, bushings, conveyor belts, windshield wipers, rubber components for aerospace and marine equipment, vehicle track elements, seals, liners, gaskets, wheels, bumpers, anti-vibration systems and the like.

### SUMMARY

One aspect is a method of preparing an elastomer composite, comprising:
(a) charging a mixing chamber of a batch elastomer mixer with at least an elastomer and a filler through a ram enclosure;
(b) mixing the elastomer and the filler in the mixing chamber, which includes:
   (i) rotating one or more rotors disposed in the mixing chamber,
   (ii) moving a ram through a ram space towards the mixing chamber to push the elastomer and the filler in the ram enclosure downwards into the mixing chamber, the ram space defined by the ram enclosure, and
   (iii) directing a flow of gas through the ram space from a vent inlet to a vent outlet disposed in the ram enclosure, the flow of gas passing through the ram space and entraining at least a portion of a vapor resulting from the mixing; and
(c) discharging the elastomer composite from the mixing chamber.

In some embodiments, a minimum flowrate of the flow of gas through the ram space is at least 200 Nm³/h, at least 400 Nm³/h, at least 500 Nm³/h, at least 750 Nm³/h, at least 1000 Nm³/h, at least 1200 Nm³/h, at least 1500 Nm³/h, at least 2000 Nm³/h, at least 2500 Nm³/h, at least 3000 Nm³/h, or at least 4000 Nm³/h and up to 6000 Nm³/h. In some embodiments, a minimum flowrate of the flow of gas through the ram space ranges from 200 Nm³/h to 6000 Nm³/h or from 400 Nm³/h to 6000 Nm³/h. In some embodiments, the flowrate is an average flowrate. In some embodiments, the flow of gas is continuous. In some embodiments, the flow of gas is pulsed.

Some embodiments further comprise a ventilator in gaseous communication with the mixer, the ventilator being configured to direct the gas to flow from the vent inlet to the vent outlet from the ram space via the vent outlet. In some embodiments, the ventilator is selected from a fan, a blower, a gas pump, compressor, an eductor, and a venturi. In some embodiments, the ventilator is disposed at one or more of the vent inlet and the vent outlet. In some embodiments, the ventilator is disposed at the vent outlet and is configured to suction the gas from the ram space into the vent outlet.

In some embodiments, during the mixing, the method further comprises a controller configured to:
detect, via a pressure sensor, a pressure of the ram space, and
control the ventilator so that the pressure of the ram space is at the negative pressure.

In some embodiments, the controller is configured to adjust a flow of the gas directed by the ventilator so as to maintain the ram space at the negative pressure. In some embodiments, the controller is configured to adjust a flow of the gas directed by the ventilator based on mixer power.

In some embodiments, the vent inlets or outlets can be circular or oval or rectangular or square in shape.

Some embodiments further comprise selectively opening one or more of the vent inlet and the vent outlet.

Some embodiments further comprise opening one or more of the vent inlet and the vent outlet during a mixing operation and closing one or more of the vent inlet and the vent outlet during the charging.

Some embodiments further comprise blocking the vent outlet with a gate for the vent outlet while the ram is vertically disposed at or above the vent outlet.

In some embodiments, the vent inlet and the vent outlet are disposed on opposite side walls of the ram enclosure. In some embodiments, the vent inlet and the vent outlet are disposed side-by-side on a wall forming the ram enclosure.

In some embodiments, the vent inlet and the vent outlet are located in an upper portion of the ram enclosure. In some embodiments, the vent inlet and the vent outlet are located in a lower portion of the ram enclosure. In some embodiments, the vent inlet is located in an upper portion of the ram housing and the vent outlet is located in a lower portion of the ram enclosure. In some embodiments, the vent inlet is located in a lower portion of the ram housing and the vent outlet is located in an upper portion of the ram enclosure.

In some embodiments, the charging comprises charging the solid elastomer and filler through a feed hopper door disposed in the ram enclosure. In some embodiments, the vent inlet is disposed above the feed hopper door. In some embodiments, the ram enclosure includes a rear wall opposite the feed hopper door, the vent outlet being disposed in the rear wall of the ram enclosure. In some embodiments, the vent inlet is disposed in the rear wall of the ram enclosure.

Some embodiments further comprise removing airborne particulates from the ram enclosure with a hood disposed above one or more of the vent inlet and the vent outlet. Some embodiments further comprise removing airborne particulates from the ram enclosure with a hood disposed above the feed hopper door. In some embodiments, a filter or scrubber is disposed intermediate the vent outlet and the ventilator.

In some embodiments, the batch elastomer mixer further comprises a vent outlet passageway extending from the vent outlet. In some embodiments, the vent outlet passageway extends at an upward angle from the vent outlet.

In some embodiments, the batch elastomer mixer further comprises a vent inlet passageway extending from the vent inlet.

In some embodiments, the batch elastomer mixer further comprises an additional vent inlet in the form of a high-pressure gas line. In some embodiments, a total cross-sectional area of the vent inlet and optionally additional vent inlet is greater than a cross-sectional area of the vent outlet.

In some embodiments, the mixing chamber further comprises a vent plunger disposed on the mixing chamber to provide additional ventilation. In some embodiments, a total cross-sectional area of the vent outlet and optionally additional vent outlet is greater than a cross-sectional area of the vent inlet.

In some embodiments, the filler is a wet filler comprising a liquid, at least a portion of which is evaporated during the mixing to generate the vapor.

In some embodiments, the charging in (a) further comprises charging the mixer with at least one coupling agent.

In some embodiments, the charging of filler in (a) comprises charging the mixer with the filler contained in low melt bags.

### BRIEF DESCRIPTION OF THE DRAWING(S)

References are made to the accompanying drawings that form a part of this disclosure, and which illustrate embodiments in which the systems and methods described in this Specification can be practiced.

FIG. 1 illustrates a schematic cross-sectional view of an elastomer mixer according to an embodiment.

FIG. 2 illustrates a schematic cross-sectional view of an elastomer mixer according to another embodiment.

FIG. 3 illustrates a ventilation configuration according to an embodiment.

FIG. 4 illustrates a ventilation configuration according to another embodiment.

FIG. 5 illustrates a ventilation configuration according to yet another embodiment.

Like reference numbers represent like parts throughout.

### DETAILED DESCRIPTION

Methods are disclosed herein for providing ventilation for a mixer that processes or prepares elastomer composites.

A good dispersion of reinforcing filler in rubber compounds has been recognized as a factor in achieving mechanical strength and consistent elastomer composite and rubber compound performance. Commercially, filler is dispersed in the rubber under dry mixing conditions with a batch (internal) mixer. For example, more intensive mixing can improve reinforcing filler dispersion, but can degrade the elastomer into which the filler is being dispersed. This is especially problematic in the case of natural rubber, which is highly susceptible to mechanical/thermal degradation, especially under dry mixing conditions.

Under typical dry mixing conditions in a batch mixer, little or no vapor or moisture or steam emission will occur. However, there are certain rubber mixing conditions that can result in the release of significant amounts of vapor or steam: the mixing of filler with a latex or emulsion that has not been completely dewatered (e.g., as disclosed in PCT Publ. No. WO 2022/125683, the disclosure of which is incorporated by reference herein); silica-rubber mixing in the presence of coupling agents to enhance the reinforcing properties, generating ethanol; and mixing wet filler with solid elastomer, as described in PCT Publ. No. WO 2020/247663, the disclosure of which is incorporated by reference herein, which enables the batch time and temperature to be controlled beyond that attainable with known dry mixing processes.

Generation of vapors, such as, steam, can affect the mixing process in one or more ways: the vapors can condense along the walls of the ram space, which can foul the ram space with entrained particles and/or result in condensate dropping back into the mixing chamber and interfering with the mixing; increases the potential for safety hazards, including the buildup of excess pressure; and/or the release of steam/vapor into spaces where operators may be located. Such undesired effects can arise during, e.g., the mixing of a wet filler (or liquid and filler charged separately) with solid elastomer, or the mixing of a filler (wet or dry) with a coagulum (e.g., as described in PCT Publ. No. WO 2022/125683 A1, the disclosure of which is incorporated by reference herein), or the mixing of silica with elastomer in the presence of a coupling agent in which ethanol is released. When mixing results in the generation of vapor, large variations in vapor flow can occur during a batch cycle. In some instances, the maximum vapor rate can be twice the average vapor rate during parts of the batch cycle, or conversely, the vapor rate can be almost zero when the ram is raised, as occurs when additional ingredients are added to the mixer.

It has been discovered that the current designs of typical elastomer mixers do not enable adequate ventilation, e.g., when the feed hopper door is closed after charging of at least the elastomer and filler. While the feed hopper door can remain open during the mixing, which can provide some ventilation, operation with the feed hopper door open is generally not considered safe. Operating a mixer with an open feed hopper door can expose operators to large amounts of vapors and particles and can also expose them to the risk of sudden release of built-up pressure. Moreover, excess vapor generation can still occur. Unless stated otherwise, mixing processes disclosed herein are performed with the feed hopper door closed.

Disclosed herein are methods of preparing an elastomer composite comprising at least an elastomer and filler, in which the mixing of at least the elastomer and filler is performed with sufficient ventilation of the ram space. In the present method, a flow of gas is directed through the ram space from a vent inlet to a vent outlet, both of which are disposed in the ram enclosure. For mixing processes in which a vapor results from the mixing, the flow of gas passing through the ram space can entrain at least a portion of the vapor and remove the vapor from the mixer. This vapor can be generated from the mixing, e.g., generated chemically or by evaporation of a liquid that was either added or present in one of the charged materials.

As such, methods and apparatuses are discussed herein for providing ventilation for a mixer that processes or prepares elastomer composite.

One aspect is a method of preparing an elastomer composite, comprising:
(a) charging a mixing chamber of a batch elastomer mixer with at least an elastomer and a filler through a ram enclosure;
(b) mixing the elastomer and the filler in the mixing chamber to form a mixture, which includes:
   (i) rotating one or more rotors disposed in the mixing chamber,
   (ii) moving a ram through a ram space towards the mixing chamber to push the elastomer and the filler in the ram enclosure downwards into the mixing chamber, the ram space defined by the ram enclosure, and
   (iii) directing a flow of gas through the ram space from a vent inlet to a vent outlet disposed in the ram enclosure, the flow of gas passing through the ram space and entraining at least a portion of a vapor resulting from the mixing; and
(c) discharging the elastomer composite from the mixing chamber.

One aspect is directed to a method of mixing filler and elastomer with concurrent ram space ventilation, in which the ram space is defined by a ram enclosure. The method comprises directing a flow of gas through the ram space from a vent inlet to a vent outlet, in which the inlet and outlet are positioned on a ram enclosure.

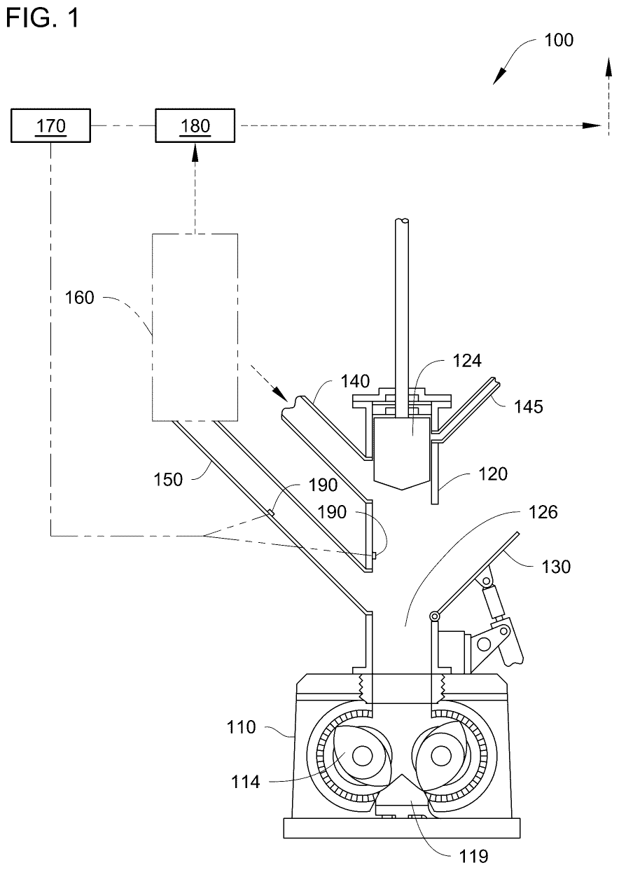

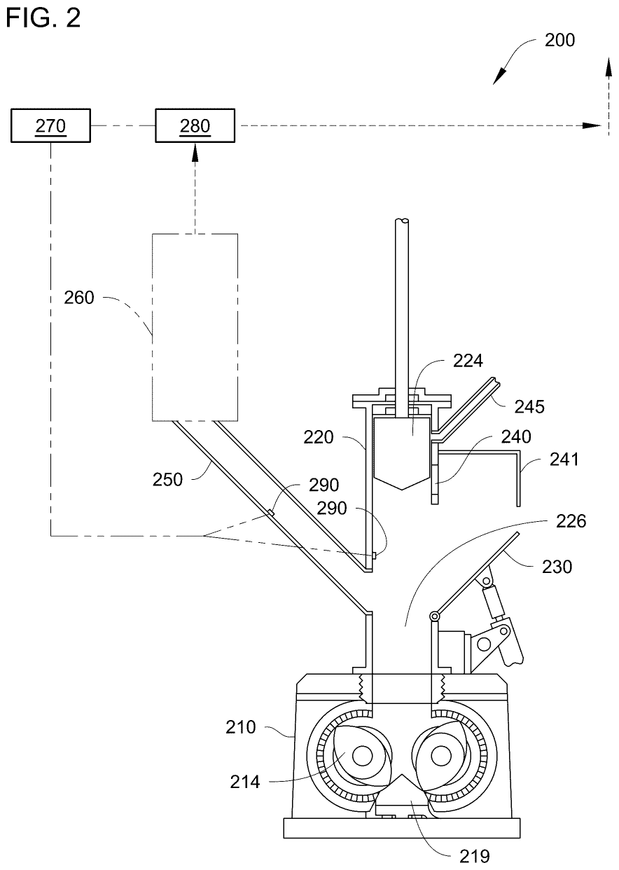

FIGS. 1 and 2 illustrate an elastomer mixer 100, 200 for processing elastomeric material, according to an embodiment. The elastomer mixer 100, 200 can be any suitable mixer that is capable of combining (e.g., mixing together or compounding together) a filler with elastomer (e.g., solid elastomer) to produce rubber compounds. The elastomer mixer 100, 200 can be a batch mixer. A combination of mixers and processes can be utilized in any of the methods or apparatuses disclosed herein, and the mixers can be used sequentially, in tandem, and/or integrated with other processing equipment. The elastomer mixer 100, 200 can be an internal mixer.

The elastomer mixer 100, 200 can be capable of batch processing, e.g., an internal mixer. Particular types of internal mixers are Banbury mixers, either of which can be used for the methods of forming a composite described herein. The internal mixer can be a tangential internal mixer. The internal mixer can be an intermeshing internal mixer. Other mixers include a kneading type internal mixer. Commercially available internal mixers from Farrel-Pomini, Harburg Freudenberger Maschinenbau GmbH (HF), Kobe Steel Ltd., or Pelmar Eng'r Ltd can be used.

The mixer can have any chamber capacity. An internal mixer generally includes an enclosed mixing chamber. For batch mixers, the chamber capacity can be at least 1 L, at least 2 L, at least 5 L, at least 10 L, at least 20 L, at least 50 L, at least 100 L, at least 250 L, at least 300 L, at least 600 L, or at least 1000 L, such as from 1 L to 1500 L, 10 L to 1200 L, 10 L to 1000 L, 10 L to 750 L, 10 L to 500 L, 10 L to 300 L, 10 L to 100 L, 20 L to 1500 L, 20 L to 1200 L, 20 L to 1000 L, 20 L to 750 L, 20 L to 500 L, 20 L to 300 L, 20 L to 100 L, 50 L to 1500 L, 50 L to 1200 L, 50 L to 1000 L, 50 L to 750 L, 50 L to 500 L, 50 L to 300 L, or 50 L to 100 L.

In the illustrated embodiment, the elastomer mixer 100, 200 is a batch mixer that includes one or more of a mixing chamber 110, 210, a ram enclosure 120, 220 that defines the ram space 126, 226 and includes a ram 124, 224. The elastomer mixer 100, 200 is configured to receive the filler and elastomer that is charged to the mixer 100, 200 etc., e.g., fed through a hopper door 130, 230. The ram enclosure 120, 220 can be provided adjacent to and vertically or above, e.g., on top of, the mixing chamber 110, 210. Feed hopper door 130, 230 can be configured to be opened and closed for charging or adding at least the elastomer, filler, etc. into the elastomer mixer 100, 200.

The filler can be charged to the mixer as powder, particulates, pellets, a cake, or a paste. In some instances where the filler comprises powder, particulates, pellets, and the like, charging of the mixer can lead to contamination of the surrounding areas. In some embodiments, the filler can be contained in low melt bags, e.g., bags having a melting point temperature of less than 90° C., or less than 80° C., e.g., a melting point temperature ranging 60° C. to 90° C., or from 60° C. to 80° C. The bags can comprise polymers such as ethylene vinyl acetate copolymer (EVA) (commercially available as Lomel® 160 or 180 bags from J.D. Drasner & Co., Inc.) or syndiotactic 1,2-polybutadiene (SPB) (commercially available as MELBAG™ M, S, or SS from ENEOS Materials Trading Co., Ltd.), the latter being capable of mixing with the elastomer and reacting with curing agents to crosslink. Such bags can have a film thickness strong enough to load the filler into the mixer without breaking but not too thick to avoid adding unnecessary quantities of bag material. For example, the bags can have a film thickness ranging from 0.03 mm to 1 mm, e.g., ranging from 0.03 mm to 0.8 mm, or from 0.03 mm to 0.7 mm, or from 0.03 mm to 0.1 mm.

The ram space 126, 226 is configured or otherwise provided for receiving the ram 124, 224 along a vertical travel thereof and/or for receiving the filler, elastomer, etc. for charging into the mixing chamber 110, 210, e.g., configured as a chute. In some embodiments, the ram enclosure 120, 220 can have a rectangular cross-section. While the ram enclosure 120, 220 has been discussed as having a rectangular cross-section, such disclosure is not intended to be limiting. Rather, it is understood that the ram enclosure 120, 220 can have other geometric cross-sections, such as, triangular, circular, or the like, and/or configured for corresponding to a shape of the ram 124, 224.

The ram 124, 224 is lowered to push the filler and elastomer to the mixing chamber 110, 210 where mixing commences upon operating rotors 114, 214 in the chamber 110, 210. The ram 124, 224 which can also be referred to as a “floating weight” or a “plunger,” is configured to vertically move towards and away from the mixing chamber 110, 210 within the ram space 126, 226 e.g., to apply pressure to the mixture and/or confine the mixture within the mixing chamber 110, 210. The ram 124, 224 can have various shapes and configurations for applying the pressure to the mixture depending on the shape and/or configuration of the mixing chamber 110, 210 and/or ram space 126, 226. In some embodiments, the ram 124, 224 can be V-shaped (in which the “V” points in the direction of the mixing chamber 110, 210), such that ram 124, 224 can be configured or otherwise provided as an upper side of the mixing chamber 110, 210, when the ram 124, 224 is in the extended position, e.g., ram down.

The mixing chamber 110, 210 includes one or more rotors 114, 214 driven by a motor (not shown). The rotors 114, 214 can be intermeshing rotors, tangential rotors, kneading rotor(s), etc. capable of mixing and dispersing the filler in the elastomer. A drop door assembly 119, 219 can be provided at an exit of the mixing chamber 110, 210 for discharging or dumping the masterbatch and/or composite from the elastomer mixer 100, 200.

As shown in FIGS. 1 and 2, vent inlet 140, 240 and the vent outlet 150, 250 are disposed in the ram enclosure 120, 220 to enable ventilation by allowing the release or relief of excess vapor (e.g., steam) and/or pressure in the ram enclosure 120, 220. The vent inlet 140, 240 is configured to supply a gas (e.g., air) to the ram enclosure 120, 220 whereas the vent outlet 150, 250 is configured to discharge the gas and any entrained vapor, liquid, and/or particles from the ram enclosure 120, 220 that flows through the ram space 126, 226. In some embodiments, the gas is dry gas and/or has a low relative humidity, e.g., less than at or about 40%, and/or is provided at a temperature between at or about 20-30° C. In other embodiments, the gas can be heated to temperatures greater than 25° C., e.g., from 30° C. to 100° C. In other embodiments, the gas can be nitrogen, carbon dioxide, a halogen gas, or otherwise inert gas that can be used to sweep or entrain the vapor formed during the mixing, e.g., is a carrier gas to carry and/or transport vapor resulting from the mixing. In some embodiments, the gas is air, which can be dried air or ambient air (e.g., having the humidity of the environment in which the mixer is located).

The vent inlet 140, 240 and/or the vent outlet 150, 250 can be open connections or can include piping or ducts having the appropriate dimensions to allow a sufficient flow. The sizing of the vent inlet 140, 240 and the vent outlet 150, 250 can be determined by one skilled in the art based on the mixer size and/or volumetric flowrate through the vent inlet or vent outlet of the elastomer mixer 100, 200. For example, in some embodiments, the vent outlet 150, 250 can be sized to have an area that is between at or about 10% to 50% of the cross-section of the ram space 126, 226 to avoid high local velocities, which could entrain particulate ingredients. In some embodiments, a flowrate of the flow of gas is lower at the vent inlet 140, 240 relative to the vent outlet 150, 250 to prevent filler loss and to accelerate removal of airborne particulates from the ram space 126, 226. In some embodiments, the vent inlet 140, 240 has an opening area (cross-sectional area) greater than an opening area (cross-sectional area) of the vent outlet 150, 250. In other embodiments, the vent outlet 150, 250 an opening area (cross-sectional area) greater than an opening area (cross-sectional area) of the vent inlet 140, 240. The vent inlet and/or outlet can have the same or different shapes and can be of any shape, e.g., circular, square, rectangular, oval, and any other shapes known for inlets and/or outlets and/or piping, and the like.

The vent inlet 140, 240 and the vent outlet 150, 250 can each include piping and a gate or valve (not shown) for selectively opening and closing or blocking the vent inlet 140, 240 and/or vent outlet 150, 250. The gate or valve can be a knife gate, butterfly valve, needle valve, solenoid valve, or the like that is configured to selectively open and close the respective vents 140, 240 and 150, 250 (and/or partially open at one or more open positions, e.g., variable opening widths). In some embodiments, the gates or valves can be provided in positions in the piping where condensate or other build-up does not accumulate, e.g., to avoid blockage and/or to avoid seal leakage.

As illustrated in FIG. 1, in some embodiments, the vent inlet 140 and the vent outlet 150 are provided at the ram space 126, in which the vent outlet 150 is provided at a position that is vertically below, e.g., at a lower position, than the vent inlet 140. Without wishing to be bound by theory, it is understood that by having the vent outlet 150 below the vent inlet 140, the gas drawn from the vent inlet 140 can be used to entrain vapor resulting from the mixing of the elastomer and filler, or at least a portion thereof, in the mixing chamber 110 by flowing gas through the ram space 126. However, alternative arrangements are also envisioned as along as the arrangement of the vent inlet 140 and the vent outlet 150 allow for adequate ventilation of the elastomer mixer 100.

As illustrated in FIG. 2, a vent inlet 240 and vent outlet 250 are disposed on opposite sides of the ram enclosure 220 to provide ventilation of the elastomer mixer 200 by allowing the release or relief of excess vapor (e.g., steam) and/or pressure in the ram enclosure 220. The vent inlet 240 positioned above the feed hopper door 230 is configured to supply a gas (e.g., air) to the ram enclosure 220. In some embodiments, the elastomer mixer 200 can include a cover 241 provided vertically above the vent inlet 240. The cover 241 can be provided surrounding the vent inlet 240, e.g., to prevent foreign materials from entering the elastomer mixer 200 and/or prevent accidental ejection, e.g., steam, from being discharged externally of the elastomer mixer 200, e.g., into the operating space around the elastomer mixer 200.

In many prior mixer configurations in which a vent inlet is not provided above a feed hopper door 230 (or in any other part of the ram enclosure), ventilation can occur when a feed hopper door is open, i.e., ventilation cannot occur once the feed hopper door is closed in these prior configurations. Mixing with the feed hopper door open, however, is not considered safe and thus, mixing is typically performed with the feed hopper door closed. Accordingly, positioning a vent inlet 240 above the feed hopper door provides the necessary inlet gas flow above the feed hopper door 230, when the feed hopper door 230 is closed, e.g., for mixing. The vent outlet 250 is disposed on an opposite side of the vent inlet 240 to allow optimal gas flow through the ram space 226. Vent outlet 250 is configured to discharge the gas and any entrained vapor, liquid, and/or particles from the ram enclosure 220 that flows through the ram space 226. Like the embodiment of FIG. 1, ram enclosure 220 can further include a high-pressure gas (air) line 245. In some embodiments, the high-pressure gas line 245 can replace vent inlet 240.

Referring to FIGS. 1 and 2, in some embodiments, the elastomer mixer 100, 200 can further include a ventilator 180, 280 that is in gaseous communication with the elastomer mixer 100, 200 and configured to direct gas to flow from the vent inlet 140, 240 to the vent outlet 150, 250 through the ram space 126, 226. The ventilator 180, 280 can be a fan (e.g., extraction fan, variable speed fan, a centrifugal fan with an open impeller), a blower, a gas pump, compressor, an eductor, a venturi, or the like. It is understood that the ventilator 180, 280 can be fluidly connected or coupled to one or more of the vent inlet 140, 240 or the vent outlet 150, 250 (as depicted in FIGS. 1 and 2). In some embodiments, ventilator 180, 280 can be fluidly connected or coupled via the vent outlet passageway which routes the vapor, e.g., steam, and gas, e.g., air, mixture to suitable equipment, such as a filter or scrubber 160, 260 to remove any entrained particulates, e.g., solids and/or liquids (e.g., droplets). In some embodiments, the ventilator 180, 280 can be configured to create positive pressure for pushing gas through the ram space 126, 226 via the vent inlet passageway and vent inlet 140, 240. In some embodiments, the ventilator 180, 280 can be configured to create negative pressure for suctioning the gas through the ram space 126, 226. The ventilator 180, 280 can be provided at an exit of and/or above the vent outlet 150, 250 e.g., with a filter or scrubber 160, 260 disposed intermediate the vent outlet 150, 250 and ventilator 180, 280 as depicted in FIGS. 1 and 2, such that the ventilator 180, 280 is configured to create negative pressure for suctioning the gas through the ram space 126, 226 to entrain vapor that results/or is generated from the mixing.

In some embodiments, the ventilator 180, 280 is a variable speed fan such that the speed of the van can be controlled to control the amount of gas drawn through the ram space 126, 226, e.g., to control the amount of vapor removed from the ram space 126, 226. In some embodiments, the ventilator 180, 280 can be configured or otherwise provided to operate in a pulsed mode, e.g., every 5 seconds, 30 seconds, 1 minutes, 2 minutes, 5 minutes, or the like, or at intermittent or continuous mode(s).

In some embodiments, the ventilator 180, 280 is configured to control to a minimum volumetric flowrate of the gas through the ram space 126, 226 of at least at least 200 Nm³/h, at least 400 Nm³/h, at least 500 Nm³/h, at least 750 Nm³/h, at least 1000 Nm³/h, at least 1200 Nm³/h, at least 1500 Nm³/h, at least 2000 Nm³/h, at least 2500 Nm³/h, at least 3000 Nm³/h, or at least 4000 Nm³/h and up to 6000 Nm³/h. It is appreciated that the flowrate of the gas can be based on the size of the mixer 100, 200, e.g., the larger the mixer, the greater the flowrate of gas. In some embodiments, the ventilator 180, 280 is configured to have a minimum flowrate of the gas through the ram space in a range from 200 Nm³/h to 6000 Nm³/h, or from 400 to 6000 Nm³/h., e.g., from 200 Nm³/h to 5000 Nm³/h, from 200 Nm³/h to 4000 Nm³/h, from 400 Nm³/h to 5000 Nm³/h, or from 400 Nm³/h to 4000 m³/h. In some embodiments, the flowrate can be at normal/standard conditions, e.g., STP (working temperature=20° C. at 1 atm; “N” refers to normal condition 0° C., 1 atm). In some embodiments, the flowrate of the flow of gas through the ram space 126, 226 is the average flowrate. In some embodiments, the flowrate may be adjusted based on the elastomer and/or filler type.

A hood (not shown) can be configured to remove vapor, airborne particulates and the like during the mixing process. The hood can be disposed above the vent inlet, or vent outlet, or both. In some embodiments, the hood can include and/or be connected to a separate ventilator that provides a negative pressure through the ram space 126, 226 and/or connected to a ventilator 180, 280.

The controller 170, 270 is configured, designed, or otherwise programmed to provide operational control of the elastomer mixer 100, 200, e.g., a processor enabled controller programmable to provide operational control. In some embodiments, the controller 170, 270 is electrically connected (or wirelessly connected) (referred to herein as “connected”) to one or more components of the elastomer mixer 100, 200 such as one or more sensors 190, 290, the ventilator 180, 280, the mixer 110, 210, the ram 124, 224, the feed hopper door 130, 230, etc. Sensor 190, 290 can be one or more of pressure sensor, moisture sensor, and/or temperature sensor. Sensor 190, 290 can be positioned in one or more locations, such as in an inner wall of the ram enclosure 120, 220 in ram space 126, 226 e.g., in close proximity to the vent outlet 150, 250 or in an inner wall of a piping leading from vent outlet 150, 250. In some embodiments, the controller 170, 270 is configured to detect, via sensor 190, 290 provided in the ram space 126, 226, a pressure of the ram space 126, 226 and control the ventilator 180, 280 so that the pressure of the ram space 126, 226 is maintained at the negative pressure, e.g., increase flowrate of the gas draw if a greater negative pressure is necessary.

In some embodiments, during a loading or charging operation, controller 170, 270 can be configured to fully or partially close one or more of the vent inlet 140, 240 or the vent outlet 150, 250 e.g., by closing gate(s) or valve(s) (not shown) within the inlet 140, 240 and/or outlet 150, 250.

In some embodiments, the ram enclosure can have more than one vent inlet in combination with one or more vent outlets to achieve a desired flowrate. In some embodiments, an additional vent inlet can take the form of a high-pressure gas line 145, 245 (as illustrated in FIGS. 1 and 2) for providing high pressure gas to the ram space 126, 226. In some embodiments, the high-pressure line 145, 245 is provided in addition to vent inlet 140, 240. In other embodiments. embodiments, the high-pressure line 145, 245 can be the vent inlet, e.g., replaces vent inlet 140, 240.

In some embodiments, a vent outlet (not shown) can be positioned in the mixing chamber 110, 220 in addition to vent outlet 150, 250. The vent outlet on the mixing chamber can be, e.g., a vent plunger designed to achieve a desired flowrate and/or to allow periodic or pulsed or continuous venting. Examples of a vent plunger are described in U.S. Provisional Appl. No. 63/707,506, filed Oct. 15, 2024, the disclosure of which is incorporated by reference herein.

In some embodiments where there is more than one vent inlet and/or vent outlet, the vent inlet and optionally the additional vent inlet (e.g., the high-pressure gas line) has a total cross-sectional area greater than a cross-sectional area of the vent outlet or even greater than a total cross-sectional area of the vent outlet and additional vent outlet. In other embodiments where there is more than one vent outlet and/or vent inlet, the vent outlet and optionally the additional vent outlet (e.g., vent plunger) has a total cross-sectional area greater than a cross-sectional area of the vent inlet or even greater than a total cross-sectional area of the vent inlet and additional vent inlet.

In some embodiments, one or more of the ram enclosure 120, 220 or the outlet vent 150, 250 can be insulated to reduce condensation along the walls of the ram space and/or mixing chamber.

While FIGS. 1 and 2 illustrate the elastomer mixer 100, 200 for processing or preparing elastomer material, it is understood that such disclosure is not intended to be limiting. Rather, it is understood that the elastomer mixer 100, 200 can be part of a larger mixing apparatus, which can include one or more of mixer(s), extruder(s), cutting device(s), dryer(s), baler(s), rollers, or the like. It is further understood that the elastomer mixer 100, 200 can also be provided as a separate component/operation for the mixing apparatus or provided a part of the mixing apparatus, e.g., a single/integrated unit.

While various positionings of the vent inlet(s) 140, 240 and the vent outlet(s) 150, 250 are discussed above, it is understood that such disclosure is not intended to be limiting. Rather, it is understood that the vent inlet(s) 140, 240 and/or the vent outlet(s) 150, 250 can have various configurations and/or positions along the ram enclosure 120, 220 such that gas, such as, air, can be drawn through the ram space 126, 226 to provide sufficient ventilation for the elastomer mixer 100, 200, e.g., when the elastomer mixer is used for mixing processes that result in the generation of vapor. For example, in some embodiments, the vent inlet and the vent outlet can be disposed side-by-side in the ram enclosure 120, 220, e.g., on the same side or wall of the ram enclosure 120, 220. In other embodiments, the vent outlet can be provided above the ram enclosure 120, 220 along a vertical direction to provide sufficient ventilation of the ram space 126, 226, e.g., to allow gas to be drawn through the ram space to entrain at least a portion of the vapor. In some embodiments, the vent outlet and/or the vent inlet can be provided vertically and located in an upper portion of the ram enclosure 120, 220 (e.g., above the midpoint of the ram enclosure), to provide further circulation of the gas to remove the vapor, e.g., above the ram enclosure 120, 220, such as, in the upper portion of the ram enclosure 120, 220 and/or through the housing of the pneumatic actuator. In some embodiments, the vent inlet and the vent outlet are disposed on opposite sides of the ram space 126, 226, and the ram space 126, 226 is disposed between the vent inlet and the vent outlet. In some embodiments, the vent outlet and/or the vent inlet is located in a lower portion of the ram enclosure 120, 220 (e.g., below the midpoint of the ram enclosure), e.g., closer to the mixing chamber 110, 210. In some embodiments, the vent inlet is disposed above the feed hopper door 130, 230 and/or the ram enclosure 120, 220 includes a rear wall opposite to the feed hopper door 130, 230, and the vent outlet is disposed in the rear wall of the ram enclosure 120, 220. In some embodiments, the vent inlet is disposed in the rear wall of the ram enclosure 120, 220. In some embodiments, the vent inlet and the vent outlet are disposed in opposing sidewalls of the ram enclosure 120, 220, e.g., walls adjacent to the feed hopper door 130, 230. In some embodiments, the vent inlet is located in an upper portion of the ram enclosure and the vent outlet is located in a lower portion of the ram enclosure; or the vent inlet is located in a lower portion of the ram enclosure and the vent outlet is located in an upper portion of the ram enclosure. As such, based on the positioning of the vent inlet and the vent outlet, a ventilator 180, 280 can be configured to draw gas or push gas, such as, air, through the ram space 126, 226 to provide sufficient ventilation for the elastomer mixer 100, 200 and/or configured to provide safety functionality by allowing the release or relief of excess vapor (e.g., steam) and/or pressure in the ram enclosure 120, 220 and/or ram space 126, 226.

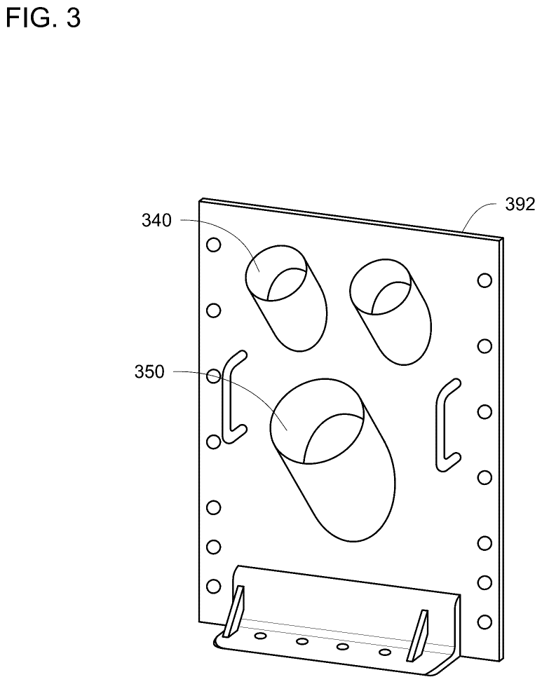

For example, FIGS. 3-5 illustrate various embodiments of the vent inlet 140, 240 and vent outlet 150, 250 that can be used with the elastomer mixer 100, 200, as discussed above.

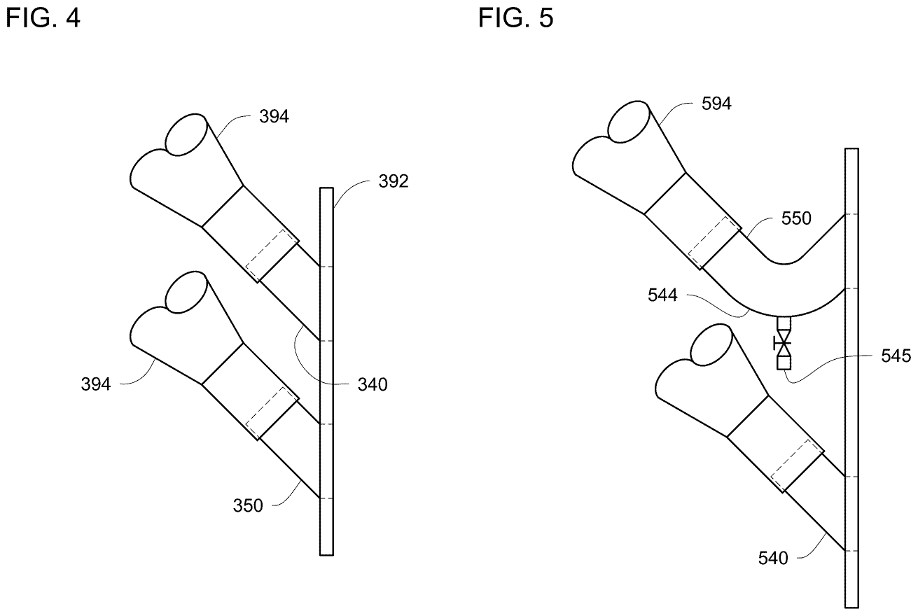

As illustrated in FIGS. 3-4, in some embodiments, one or more vent inlets 340 and one or more vent outlets 350 can be provided on a back plate 392 of the elastomer mixer, e.g., 100, 200, in the ram space 126, 226. The back plate 392 can be provided on a wall of the ram enclosure 120, 220 defining the ram space 126, 226, opposite from the feed hopper door 130, 230. The one or more vent inlets 340, in this embodiment, are provided vertically above the vent outlet 350. The one or more vent inlets 340 and the vent outlets 350 can include piping provided at an upward angle from the vent inlet 340 and/or the vent outlet 350 for example, between at or about 50 degrees and 90 degrees from the wall the ram enclosure 120, 220.

As illustrated in FIG. 4, in some embodiments, the one or more vent inlets 340 and/or the one or more vent outlets 350 can include vent connections 394 that are configured for connecting to the one or more vent inlets 340 and the one or more vent outlets 350 to one or more of a vent outlet passageway and/or vent inlet passageway, respectively. In some embodiments, the vent outlet passageway and/or the vent inlet passageway extends from the respective vent outlet 350 or vent inlet 340 at an upward angle relative to the vent outlet 350 or vent inlet 340. The vent connections 394 can be provided for coupling vent ducts and/or piping having different geometries or materials to the vent inlet 340 and/or vent outlet 350, e.g., round to straight adaptor and/or rubber to steel, or the like.

FIG. 5 illustrates another embodiment of a vent inlet 540 and vent outlet 550 assembly. In this embodiment, one or more of the vent inlet 540 and/or the vent outlet 550 can be provided on a wall of the ram enclosure 120, 220 of the elastomer mixer 100, 200. The vent inlet 540 and the vent outlet 550 can be provided on an opposite wall of the ram enclosure 120, 220 defining the ram space 126, 226 than the feed hopper door 130, 230. The vent inlet 540 and/or the vent outlet 550 includes piping that has a bent portion 544 that is bent away from the ram enclosure 120, 220, e.g., in a downward direction, e.g., towards a bottom of the elastomer mixer 100, 200, and is then angled in an upward direction. As such, the bent portion 544 can be configured or otherwise provided for collecting any condensate formed from the vapor generated from the mixing of the elastomer and the filler. In some embodiments, the bent portion 544 can include a valve 545, e.g., manual hand valve or automatic valve, such as a solenoid, for draining the condensate from the bent portion 544. The vent inlet 540 and/or the vent outlet 550 can further include vent connections 594 that are configured for connecting to the vent inlet 540 and the vent outlets 550 to one or more of a vent outlet passageway and/or vent inlet passageway, respectively. The vent connections 594 can be provided for coupling vent ducts and/or piping having different geometries or materials to the vent inlet 540 and/or vent outlet 550, e.g., round to straight adaptor and/or rubber to steel, or the like.

The methods of processing or preparing the elastomeric composite, as discussed herein, is as follows. The method of preparing an elastomer composite includes charging a mixing chamber, e.g., 110, 210, of a batch elastomer mixer, e.g., 100, 200, with at least an elastomer, a filler, etc. through a ram enclosure, e.g., 120, 220. The method further includes mixing the elastomer and the filler in the mixing chamber, e.g., 110, 210, to form a mixture. The mixing includes rotating one or more rotors, e.g., 114, 214, disposed in the mixing chamber, e.g., 110, 210, moving a ram, e.g., 124, 224, through a ram space, e.g., 126, 226, towards the mixing chamber, e.g., 110, 210, to push the elastomer and the filler in the ram enclosure, e.g., 120, 220, downwards into the mixing chamber, e.g., 110, 210, directing a flow of gas through the ram space, e.g., 126, 226, from a vent inlet, e.g., 140, 240, to a vent outlet, e.g., 150, 250, disposed in the ram enclosure, e.g., 120, 220, the flow of gas passing through the ram space, e.g., 126, 226, and entraining at least a portion of vapor resulting from the mixing, and discharging the elastomer composite from the mixing chamber, e.g., 110, 210.

In some embodiments, during a loading or charging step or operation, the method can include closing one or more of the vent inlet, e.g., 140, 240 or the vent outlet, e.g., 150, 250, e.g., by closing the gate(s) or valve(s).

During a mixing operation, the method can include closing the feed hopper door, e.g., 130, 230, moving the ram, e.g., 124, 224, to the extended position, which extends the ram, e.g., 124, 224, through the ram space, e.g., 126, 226, towards the mixing chamber, e.g., 110, 210, to push the filler, elastomer, etc. towards the mixing chamber and opening one or more of the gates or valves, once the ram, e.g., 124, 224, is positioned to form an upper side of the mixing chamber, e.g., 110, 210. As discussed above, during the mixing operation, at least a portion of vapor resulting from the mixing is removed. For example, vapor from the mixture can flow into the ram space, e.g., 126, 226, such that vapor (and/or particles and/or liquid) is present in the ram space, e.g., 126, 226, e.g., via passage of the vapor through clearance between the ram, e.g., 124, 224, and the mixer, e.g., 110, 210 (e.g., throat wear plates) and/or between the ram, e.g., 124, 224, and the ram space, e.g., 126, 226.

The method can further include directing the flow of gas through the ram space, e.g., 126, 226, by controlling the ventilator, e.g., 180, 280, to pass (or draw) the gas through the ram space, e.g., 126, 226, to entrain and/or mix the vapor with the gas and/or particles and/or liquid, e.g., join or partially displace the vapor and/or particles and/or liquid from the ram space, e.g., 126, 226. In some embodiments, the method includes controlling the flow of gas to maintain a negative pressure in the ram space, e.g., 126, 226, by controlling the ventilator, e.g., 180, 280, such as, controlling speed, or positions of one or more of the vent inlet, e.g., 140, or vent outlet, e.g., 150, 250. In some embodiments, the controller 170, 270 is configured to adjust a flow of the gas directed by the ventilator 180, 280 based on mixer power. In some embodiments, the gates or valves are selectively opened, e.g., based on the operation and amount of vapor to be entrained or swept from the ram space.

In some embodiments, the method includes controlling the ventilator, e.g., 180, 280, that is in gaseous communication with the elastomer mixer 100, 200, such that the gas flows from the vent inlet, e.g., 140, 240, to the vent outlet, e.g., 150, 250, from the ram space, e.g., 126, 226, via the vent outlet, e.g., 150, 250. In some embodiments, the ventilator, e.g., 180, 280, can be disposed at one or more of the vent inlet, e.g., 140, 240, or the vent outlet, e.g., 150, 250. In some embodiments, the method can include controlling the ventilator, e.g., 180, 280, such that the pressure in the ram space, e.g., 126, 226, is maintained at a negative pressure, e.g., suction.

In some embodiments, the method includes controlling the ventilator, e.g., 180, 280, such that the flowrate of the flow of gas is lower at the vent inlet, e.g., 140, 240, relative to the vent outlet, e.g., 150, 250, to prevent filler loss and to accelerate removal of airborne particulates from the ram enclosure, e.g., 120, 220.

In some embodiments, the method includes controlling the ventilator 180, 280 to maintain a minimum flowrate of the flow of gas through the ram space, e.g., 126, 226, that is at least 400 m³/h, preferably at least 500 m³/h, more preferably at least 750 m³/h, more preferably at least 1000 m³/h, more preferably at least 1200 m³/h, more preferably at least 1500 m³/h, more preferably at least 2000 m³/h, more preferably at least 2500 m³/h, more preferably at least 3000 m³/h. It is understood that the flowrate can depend on the size of the elastomer mixer, e.g., 100, 200.

In some embodiments, the ventilation can be performed with an open feed hopper door 130, 230 to function as an additional air inlet. The gas flow will pass from the inlet 140, 240 and the feed hopper door 130, 230 and exit the ram space through vent outlet 150, 250, to prevent particulates from escaping through the feed hopper door 130, 230. The use of the feed hopper door 130, 230 may require reduction in the gas flow to prevent entrainment of the feed materials.

In other embodiments, an additional gas stream can be introduced into the outlet 150, 250 upstream of filter or scrubber 160, 260, e.g., a venturi scrubber. This can ensure that the gas flow through scrubber 160, 260 does not drop to a level below what is required for adequate removal of particulate material.

Once the mixing is completed, the method includes opening the drop door assembly, e.g., 119, 219, for discharging or dumping the masterbatch and/or composite from the elastomer mixer, e.g., via mixing chamber, e.g., 110, 210. In some embodiments, the discharging step from the mixing chamber, e.g., 110, 210, occurs and results in a composite comprising the filler dispersed in the elastomer at a loading of at least 1 phr, e.g., at least 10 phr or at least 20 phr. During the mixing cycle, the mixture experiences an increase in temperature. It is desired to avoid excessive temperature increases that would degrade the elastomer. Discharging, (e.g., “dumping” in batch mixing), can occur on the basis of time or temperature or specific energy or power or torque applied to the rotors, rotor speed, or a combination of one or more of such parameters. The one or more parameters can be selected to minimize degradation of the elastomer and/or achieve a target property, e.g., moisture content, Mooney viscosity, etc., of the composite. Methods for determining discharge are described in GB2163061B, U.S. Pat. Nos. 4,818,113A, 6,817,748B2, EP3266576B1, KGK Rubberpoint July-August, p. 28 (2009), and KGK Rubberpoint vol. 10, p. 31 (2015) (accessible at www.kgk-rubberpoint.de), the disclosures of which are incorporated by reference herein.

As such, in some embodiments, the method of preparing the elastomer composite provides sufficient ventilation of the elastomer mixer, e.g., to prevent and/or reduce condensation in the ram enclosure 120, 220 and/or provide release of excess pressure build up in the mixing chamber. That is, when the generation of vapors, whether by evaporation or chemical reaction, occurs at a high rate, the present method provides a flow of gas from a vent inlet and through the ram space such that the gas flow sucks or pushes the gas that entrains and/or mixes with the vapor out of the ram space via the vent outlet to outside of the elastomer mixer. Thus, the elastomer mixer provides sufficient ventilation of the vapor resulting from the mixing such that condensate is prevented or mitigated from forming on the walls of the ram space and/or does not cause excess pressure build up.

In some embodiments, the elastomeric composition is a composite comprising at least one elastomer and at least one filler having a loading of at least 20 phr.

The elastomer can be a solid elastomer, e.g., having a liquid content of 5 wt. % or less, based on the total weight of the solid elastomer, such as 4 wt. % or less, 3 wt. % or less, 2 wt. % or less, 1 wt. % or less, or from 0.1 wt. % to 5 wt. %, 0.5 wt. % to 5 wt. %, 1 wt. % to 5 wt. %, 0.5 wt. % to 4 wt. %, and the like. In other embodiments, the elastomer can be a never-dried natural rubber having water present in an amount ranging from 5% to 55% by weight, or from 10% to 55% by weight, or from 20% to 55% by weight of the never-dried natural rubber, such as a coagulum (e.g., as described in PCT Publ. No. WO 2022/125683 A1, the disclosure of which is incorporated by reference herein).

Exemplary elastomers include natural rubber (NR), functionalized natural rubber (e.g., epoxidized natural rubber (ENR)), synthetic elastomers such as styrene-butadiene rubber (SBR, e.g., solution SBR (SSBR), emulsion SBR (ESBR), or oil-extended SSBR (OESSBR)), functionalized styrene-butadiene rubber, polybutadiene rubber (BR), functionalized polybutadiene rubber, polyisoprene rubber (IR), ethylene-propylene rubber (EPDM), isobutylene-based elastomers (e.g., butyl rubber), halogenated butyl rubber (e.g., chlorinated butyl rubber (CIIR), brominated butyl rubber (BIIR)), polychloroprene rubber (CR), nitrile rubbers (NBR), hydrogenated nitrile rubber (HNBR), fluoroelastomers, perfluoroelastomers, and silicone rubber. As an option, the elastomer can be selected from at least one of natural rubber, styrene-butadiene rubber, and polybutadiene rubber, including blends thereof.

Other synthetic polymers that can be used in the present methods (whether alone or as blends) include hydrogenated SBR, and thermoplastic block copolymers (e.g., such as those that are recyclable). Synthetic polymers include copolymers of ethylene, propylene, styrene, butadiene and isoprene. Other synthetic elastomers include those synthesized with metallocene chemistry in which the metal is selected from Ce, Pr, Nd, Sm, Gd, Tb, Dy, Ho, Tm, Yb, Lu, Co, Ni, and Ti. Polymers made from bio-based monomers can also be used, such as monomers containing modern carbon as defined by ASTM D6866, e.g., polymers made from bio-based styrene monomers disclosed in U.S. Pat. No. 9,868,853, the disclosure of which is incorporated by reference herein, or polymers made from bio-based monomers such as butadiene, isoprene, ethylene, propylene, farnesene, and comonomers thereof.

Other exemplary elastomers include, but are not limited to, rubbers, polymers (e.g., homopolymers, copolymers and/or terpolymers) of 1,3-butadiene, styrene, isoprene, isobutylene, 2,3-dialkyl-1,3-butadiene, where alkyl may be methyl, ethyl, propyl, etc., acrylonitrile, ethylene, propylene and the like.

Other applicable elastomers that can be used in the presently disclosed methods are disclosed in PCT Publ. No. WO 2020/247663, the disclosure of which is incorporated by reference herein.

If two or more elastomers are used, the two or more elastomers can be charged into the mixer as a blend at the same time (as one charge or two or more charges) or the elastomers can be added separately in any sequence and amount. For example, the elastomer can comprise natural rubber blended with one or more of the elastomers disclosed herein, e.g., butadiene rubber and/or styrene-butadiene rubber, or SBR blended with BR, etc. For instance, the additional elastomer can be added separately to the mixer and the natural rubber can be added separately to the mixer.

The elastomer can be or include natural rubber. If the elastomer is a blend, it can include at least 50 wt. % or at least 70 wt. % or at least 90 wt. % natural rubber. The blend can further comprise synthetic elastomers such as one or more of styrene-butadiene rubber, functionalized styrene-butadiene rubber, and polybutadiene rubber, and/or any other elastomers disclosed herein.

The natural rubber may also be chemically modified in some manner. For example, it may be treated to chemically or enzymatically modify or reduce various non-rubber components, or the rubber molecules themselves may be modified with various monomers or other chemical groups such as chlorine. Other examples include epoxidized natural rubber and natural rubber having a nitrogen content of at most 0.3 wt. %, as described in PCT Publ. No. WO 2017/207912.

The at least one filler can be selected from carbonaceous materials, carbon black, silica, nanocellulose, lignin, clays, nanoclays, metal oxides, metal carbonates, pyrolysis carbon, reclaimed carbon, recovered carbon black (e.g., as defined in ASTM D8178-19, rCB), graphenes, graphene oxides, reduced graphene oxide (e.g., reduced graphene oxide worms as disclosed in PCT Publ. No. WO 2019/070514A1, the disclosure of which is incorporated by reference herein), or densified reduced graphene oxide granules (as disclosed in U.S. Prov. Appl. No. 62/857,296, filed Jun. 5, 2019, and PCT Publ. No. WO 2020/247681, the disclosures of which are incorporated by reference herein), carbon nanotubes, single-wall carbon nanotubes, multi-wall carbon nanotubes, or combinations thereof, or corresponding coated materials (e.g., silicon-treated carbon black) or chemically-treated materials thereof (e.g., chemically-treated carbon black). Other suitable fillers include carbon nanostructures (CNSs, singular CNS), a plurality of carbon nanotubes (CNTs) that are crosslinked in a polymeric structure by being branched, e.g., in a dendrimeric fashion, interdigitated, entangled and/or sharing common walls with one another. CNS fillers are described in U.S. Pat. No. 9,447,259, and PCT Appl. No. PCT/US2021/027814, the disclosures of which are incorporated by reference herein. Blends of can also be used, e.g., blends of silica and carbon black, silica and silicon-treated carbon black, and carbon black and silicon-treated carbon black. The filler can be chemically treated (e.g. chemically treated carbon black, chemically treated silica, silicon-treated carbon black) and/or chemically modified. The filler can be or include carbon black having an attached organic group(s). The filler can have one or more coatings present on the filler (e.g. silicon-coated materials, silica-coated material, carbon-coated material). The filler can be oxidized and/or have other surface treatments. There is no limitation with respect to the type of filler (e.g., silica, carbon black, or other filler) that can be used.

The filler in general, can be any conventional filler used with elastomers such as reinforcing fillers including, but not limited to, carbon black, silica, a filler comprising carbon black, a filler comprising silica, and/or any combinations thereof. The filler can be particulate or fibrous or plate-like. For example, a particulate filler is made of discrete bodies. Such fillers can often have an aspect ratio (e.g., length to diameter) of 3:1 or less, or 2:1 or less, or 1.5:1 or less. Fibrous fillers can have an aspect ratio of, e.g., 2:1 or more, 3:1 or more, 4:1 or more, or higher. Typically, fillers used for reinforcing elastomers have dimensions that are microscopic (e.g., hundreds of microns or less) or nanoscale (e.g., less than 1 micron). In the case of carbon black, the discrete bodies of particulate carbon black refer to the aggregates or agglomerates formed from primary particles, and not to the primary particles themselves. In other embodiments, the filler can have a platelike structure such as graphenes and reduced graphene oxides.

The filler can comprise a fibrous filler including natural fibers, semi-synthetic fibers, and/or synthetic fibers (e.g., nanosized carbon filaments), such as short fibers disclosed in PCT Publ. No. WO 2021/153643, the disclosure of which is incorporated by reference herein. Other fibrous fillers include poly (p-phenylene terephthalamide) pulp, commercially available as Kevlar® pulp (Du Pont).

Other suitable fillers include bio-sourced or bio-based materials (derived from biological sources), recycled materials, or other fillers considered to be renewable or sustainable include hydrothermal carbon (HTC, where the filler comprises lignin that has been treated by hydrothermal carbonization as described in U.S. Pat. Nos. 10,035,957, and 10,428,218, the disclosures of which are incorporated by reference, herein), rice husk silica, carbon from methane pyrolysis, nanocrystalline cellulose starch particles, polysaccharides, glucans, dextrans, microfibrillated cellulose, engineered polysaccharide particles, starch, siliceous earth, crumb rubber, and functionalized crumb rubber. Exemplary engineered polysaccharides include those described in U.S. Pat. Publ. Nos. 2020/0181370 and 2020/0190270, the disclosures of which are incorporated herein by reference. For example, the polysaccharides can be selected from: poly alpha-1,3-glucan; poly alpha-1,3-1,6-glucan; a water insoluble alpha-(1,3-glucan) polymer having 90% or greater α-1,3-glycosidic linkages, less than 1% by weight of alpha-1,3,6-glycosidic branch points, and a number average degree of polymerization in the range of from 55 to 10,000; dextran; a composition comprising a poly alpha-1,3-glucan ester compound; and water-insoluble cellulose having a weight-average degree of polymerization (DPw) of about 10 to about 1000 and a cellulose II crystal structure.

The carbon black can be a furnace black, a gas black, a thermal black, an acetylene black, or a lamp black, a plasma black, a recovered carbon black (e.g., as defined in ASTM D8178-19), or a carbon product containing silicon-containing species, and/or metal containing species and the like. The carbon black used in any of the methods disclosed herein can be any grade of reinforcing carbon blacks and semi-reinforcing carbon blacks. Examples of ASTM grade reinforcing grades are N110, N121, N134, N220, N231, N234, N299, N326, N330, N339, N347, N351, N358, and N375 carbon blacks. Examples of ASTM grade semi-reinforcing grades are N539, N550, N650, N660, N683, N762, N765, N774, N787, N990 carbon blacks and/or N990 grade thermal blacks.

The carbon black can have any statistical thickness surface area (STSA) such as ranging from 20 m²/g to 250 m²/g or higher. STSA (statistical thickness surface area) is determined based on ASTM Test Procedure D-5816 (measured by nitrogen adsorption). The carbon black can have a compressed oil absorption number (COAN) ranging from about 30 mL/100 g to about 150 mL/100 g. Compressed oil absorption number (COAN) is determined according to ASTM D3493. As an option, the carbon black can have a STSA ranging from 20 m²/g to 180 m²/g, or from 60 m²/g to 150 m²/g with a COAN ranging from 40 mL/100 g to 115 mL/100 g or from 70 mL/100 g to 115 mL/100 g.

As stated, the carbon black can be a rubber black, and especially a reinforcing grade of carbon black or a semi-reinforcing grade of carbon black. Carbon blacks sold under the Regal®, Black Pearls®, Spheron®, Sterling®, Propel®, Endure®, and Vulcan® trademarks available from Cabot Corporation, the Raven®, Statex®, Furnex®, and Neotex® trademarks and the CD and HV lines available from Birla Carbon (formerly available from Columbian Chemicals), and the Corax®, Durax®, Ecorax®, and Purex® trademarks and the CK line available from Orion Engineered Carbons (formerly Evonik and Degussa Industries), and other fillers suitable for use in rubber or tire applications, may also be exploited for use with various implementations. Suitable chemically functionalized carbon blacks include those disclosed in WO 96/18688 and US2013/0165560, the disclosures of which are hereby incorporated by reference. Mixtures of any of these carbon blacks may be employed. Carbon blacks having surface areas and structures beyond the ASTM grades and typical values selected for mixing with rubber, such as those described in U.S. Patent Application Publ. No. 2018/0282523, the disclosure of which is incorporated herein by reference, may be used.

With regard to the filler, as an option, being at least silica, one or more types of silica, or any combination of silica(s), can be used in any embodiment disclosed herein. The silica can include or be precipitated silica, fumed silica, silica gel, and/or colloidal silica. The silica can be or include untreated silica and/or chemically-treated silica. The silica can be suitable for reinforcing elastomer composites and can be characterized by a Brunaur Emmett Teller surface area (BET, as determined by multipoint BET nitrogen adsorption, ASTM D1993) of about 20 m²/g to about 450 m²/g; about 30 m²/g to about 450 m²/g; about 30 m²/g to about 400 m²/g; or about 60 m²/g to about 250 m²/g, from about 60 m²/g to about 250 m²/g, from about 80 m²/g to about 200 m²/g. The silica can have an STSA ranging from about 80 m²/g to 250 m²/g, such as from about 80 m²/g to 200 m²/g or from 90 m²/g to 200 m²/g, from 80 m²/g to 175 m²/g, or from 80 m²/g to 150 m²/g. Highly dispersible precipitated silica can be used as the filler in the present methods. Highly dispersible precipitated silica (“HDS”) is understood to mean any silica having a substantial ability to dis-agglomerate and disperse in an elastomeric matrix. Such dispersion determinations may be observed in known manner by electron or optical microscopy on thin sections of elastomer composite. Examples of commercial grades of HDS include, Perkasil® GT 3000GRAN silica from WR Grace & Co, Ultrasil® 7000 silica from Evonik Industries, Zeosil® 1165 MP, 1115 MP, Premium, and 1200 MP silica from Solvay S.A., Hi-Sil® EZ 160G silica from PPG Industries, Inc., and Zeopol® 8741 or 8745 silica from Evonik Industries. Conventional non-HDS precipitated silica may be used as well. Examples of commercial grades of conventional precipitated silica include, Perkasil® KS 408 silica from WR Grace & Co, Zeosil® 175GR silica from Solvay S.A., Ultrasil® VN3 silica from Evonik Industries, and Hi-Sil® 243 silica from PPG Industries, Inc. Precipitated silica with surface attached silane coupling agents may also be used. Examples of commercial grades of chemically-treated precipitated silica include Agilon®400, 454, or 458 silica from PPG Industries, Inc. and Coupsil silicas from Evonik Industries, for example Coupsil® 6109 silica.

The carbon black can be a multi-phase aggregate comprising at least one carbon phase and at least one metal-containing species phase or silicon-containing species phase, i.e., silicon-treated carbon black. In silicon-treated carbon black, a silicon containing species, such as an oxide or carbide of silicon, is distributed through at least a portion of the carbon black aggregate as an intrinsic part of the carbon black. Silicon-treated carbon blacks are not carbon black aggregates which have been coated or otherwise modified, but actually represent dual-phase aggregate particles. One phase is carbon, which will still be present as graphitic crystallite and/or amorphous carbon, while the second phase is silica, and possibly other silicon-containing species). Thus, the silicon-containing species phase of the silicon treated carbon black is an intrinsic part of the aggregate, distributed throughout at least a portion of the aggregate. Ecoblack™ silicon-treated carbon blacks are available from Cabot Corporation. The manufacture and properties of these silicon-treated carbon blacks are described in U.S. Pat. No. 6,028,137, the disclosure of which is incorporated herein by reference.

The silicon-treated carbon black can include silicon-containing regions primarily at the aggregate surface of the carbon black, but still be part of the carbon black and/or the silicon-treated carbon black can include silicon-containing regions distributed throughout the carbon black aggregate. The silicon-treated carbon black can be oxidized. The silicon-treated carbon black can contain from about 0.1% to about 50% silicon by weight, e.g., from about 0.1% to about 46.6%, from about 0.1% to about 46%, from about 0.1% to about 45%, from about 0.1% to about 40%, from about 0.1% to about 35%, from about 0.1% to about 30%, from about 0.1% to about 25%, from about 0.1% to about 20%, from about 0.1% to about 15%, from about 0.1% to about 10%, from about 0.1% to about 5%, or from about 0.1% to about 2% by weight, based on the weight of the silicon-treated carbon black. These amounts can be from about 0.5 wt. % to about 25 wt. %, from about 1 wt. % to about 15 wt. % silicon, from about 2 wt. % to about 10 wt. %, from about 3 wt. % to about 8 wt. %, from about 4 wt. % to about 5 wt. % or to about 6 wt. %, all based on the weight of the silicon-treated carbon black.

In any embodiment and in any step, a coupling agent can be introduced in any of the steps (or in multiple steps or locations) as long as the coupling agent has an opportunity to become dispersed in the composite. The filler can be silica or a silicon-treated carbon black. The coupling agent can be or include one or more silane coupling agents, one or more zirconate coupling agents, one or more titanate coupling agents, one or more nitro coupling agents, or any combination thereof. The coupling agent can be or include bis(3-triethoxysilylpropyl) tetrasulfane (e.g., Si 69 from Evonik Industries, Struktol SCA98 from Struktol Company), bis(3-triethoxysilylpropyl)disulfane (e.g., Si 75 and Si 266 from Evonik Industries, Struktol SCA985 from Struktol Company), 3-thiocyanatopropyl-triethoxy silane (e.g., Si 264 from Evonik Industries), gamma-mercaptopropyl-trimethoxy silane (e.g., VP Si 163 from Evonik Industries, Struktol SCA989 from Struktol Company), gamma-mercaptopropyl-triethoxy silane (e.g., VP Si 263 from Evonik Industries), zirconium dineoalkanolatodi (3-mercapto) propionato-O, N,N′-bis(2-methyl-2-nitropropyl)-1,6-diaminohexane, S-(3-(triethoxysilyl) propyl) octanethioate (e.g., NXT coupling agent from Momentive, Friendly, WV), and/or coupling agents that are chemically similar or that have the one or more of the same chemical groups. Additional specific examples of coupling agents, by commercial names, include, but are not limited to, VP Si 363 from Evonik Industries, and NXT Z and NXT Z-50 silanes from Momentive. Other compounds that can function as coupling agents include those compounds having a nitroxide radical, e.g., TEMPO (2,2,6,6-tetramethyl-1-piperidinyloxy radical), as disclosed in U.S. Pat. Nos. 6,084,015, 6,194,509, 8,584,725, and U.S. Publ. No. 2009/0292044, the disclosures of which are incorporated by reference herein, or nitrile oxide, nitrile imine and nitrone 1,3-dipolar compounds, as disclosed in U.S. Pat. Nos. 10,239,971, 10,202,471, 10,787,471, and U.S. Publ. No. 2020/0362139, the disclosures of which are incorporated by reference herein. The coupling agents described herein could be used to provide hydrophobic surface modification of silica (precoupled or pretreated silica) before using it in any of the processes disclosed herein. It is to be appreciated that any combination of elastomers, additives, and additional composite may be added to the elastomer composite, for instance in a compounder.

As disclosed herein, the method can comprise the mixing of silica with elastomer in the presence of a coupling agent, which can result in the release of ethanol at least a portion of which is released in the form of a vapor. The methods disclosed herein can direct a flow of gas through the ram space from a vent inlet to a vent outlet disposed in the ram enclosure, the flow of gas passing through the ram space and entraining at least a portion of ethanol vapor resulting from the mixing.

As another option, the mixing (e.g., where the filler comprises silica and/or silicon-treated carbon black) can be performed without coupling agents. Optionally, a coating agent (filler coating agent) can be introduced in any of the steps (or in multiple steps or locations) prior to discharging. Methods of mixing without coupling agents and/or with coating agents, including exemplary coating agents, are disclosed in PCT Publication No. WO 2022/125675, the disclosure of which is incorporated by reference herein.

The total loading level of the filler (single filler type or blend fillers) can be at least 20 phr, at least 30 phr, or at least 40 phr. As an option, the total loading level of the filler can range from 20 phr to 250 phr, 30 phr to 250 phr, from 30 phr to 200 phr, from 30 phr to 180 phr, from 30 phr to 150 phr, from 30 phr to 100 phr, from 30 phr to 90 phr, from 30 phr to 80 phr, from 30 phr to 70 phr, from 30 phr to 65 phr, from 30 phr to 60 phr, from 30 phr to 50 phr, from 40 phr to 250 phr, from 40 phr to 200 phr, from 40 phr to 180 phr, from 40 phr to 150 phr, from 40 phr to 100 phr, from 40 phr to 90 phr, from 40 phr to 80 phr, from 40 phr to 70 phr, from 40 phr to 65 phr, or from 40 phr to 60 phr.

In some embodiments at least 50% of the filler (e.g., at least 75% or at least 90% of the filler) is selected from carbon black, and coated and treated materials thereof. In certain embodiments at least 50% of the filler (e.g., at least 75% or at least 90% of the filler) is silica. In certain embodiments at least 50% of the filler (e.g., at least 75% or at least 90% of the filler) is silicon-treated carbon black. As an example, the carbon black can be dispersed in the elastomer at a loading ranging from 30 phr to 200 phr, from 30 phr to 70 phr, or from 40 phr to 65 phr, or from 40 phr to 60 phr. As a more specific example, with the elastomer being natural rubber alone or with one or more other elastomers, and the filler being carbon black alone or with one or more other fillers (e.g., silica or silicon-treated carbon black), the carbon black can be dispersed in the natural rubber at a loading ranging from 30 phr to 70 phr, or from 40 phr to 65 phr, or from 40 phr to 60 phr.

In some embodiments at least 50% of the filler (e.g., at least 75% or at least 90% of the filler) is selected from silica. The amount of silica present in the elastomer composite formed can be from 20 phr to 250 phr, from 20 phr to 200 phr, from 20 phr to 150 phr, from 20 phr to from 100 phr, from 30 phr to from 150 phr, from 30 phr to from 100 phr, from 25 phr to 100 phr, from 25 phr to 80 phr, from 35 phr to 115 phr, from 35 phr to 100 phr, from 40 phr to 110 phr, from 40 phr to 100 phr, from 40 phr to 90 phr, from 40 phr to 80 phr, and the like. Filler blends comprising silica can include 10 wt. % carbon black and/or silicon-treated carbon black.

The amount of silicon-treated carbon black present in the elastomer composite formed can be from 20 phr to 250 phr, from 20 phr to 200 phr, from 30 phr to 150 phr, from 40 phr to 100 phr, or from 50 phr to 65 phr.

The mixing of wet filler with solid elastomer is described in PCT Publ. No. WO 2020/247663, the disclosure of which is incorporated by reference herein. In their dry state, fillers may contain no or small amounts of liquid (e.g. water or moisture) adsorbed onto its surfaces. For example, carbon black can have 0 wt. %, or 0.1 wt. % to 1 wt. % or up to 3 wt. % or up to 4 wt. % of liquid and precipitated silica can have a liquid (e.g., water or moisture) content of from 4 wt. % to 7 wt. % liquid, e.g., from 4 wt. % to 6 wt. % liquid. Such fillers are referred to herein as dry or non-wetted fillers. A “wet filler” comprises a filler and a liquid present on a substantial portion or substantially all the surfaces of the filler, which can include inner surfaces or pores accessible to the liquid. Thus, sufficient liquid is provided to wet a substantial portion or substantially all of the surfaces of the filler prior to mixing with solid elastomer.

The wet filler can have a liquid content of at least 15% by weight relative to the total weight of the wet filler, e.g., at least 20%, at least 25%, at least 30%, at least 40%, at least 50% by weight, or from 15% to 99%, from 15% to 95%, from 15% to 90%, from 15% to 80%, from 15% to 70%, from 15% to 60%, from 15% to 65%, from 20% to 99%, from 20% to 95%, from 20% to 90%, from 20% to 80%, from 20% to 70%, from 20% to 60%, from 30% to 99%, from 30% to 95%, from 30% to 90%, from 30% to 80%, from 30% to 70%, from 30% to 60%, from 40% to 99%, from 40% to 95%, from 40% to 90%, from 40% to 80%, from 40% to 70%, from 40% to 60%, from 45% to 99%, from 45% to 95%, from 45% to 90%, from 45% to 80%, from 45% to 70%, from 45% to 60%, from 50% to 99%, from 50% to 95%, from 50% to 90%, from 50% to 80%, from 50% to 70%, or from 50% to 60% by weight, relative to the total weight of the wet filler. With these amounts, the wet filler maintains the form of a powder, particulates, pellet, cake, or paste, or similar consistency and/or has the appearance of a powder, particulates, pellet, cake, or paste. In some embodiments, the wet filler is not a slurry of filler and does not have the consistency of a liquid or slurry.

During mixing, at least a portion of the liquid can be removed by evaporation as the wet filler is being dispersed in the solid elastomer, and the surfaces of the filler can then become available to interact with the solid elastomer. The liquid of the wet filler is thus capable of being removed by evaporation (and at least a portion is capable of being removed under the recited mixing conditions) and can be a volatile liquid, e.g., volatile at bulk mixture temperatures. The volatile liquid can be or include water, e.g., at least 50 wt. % water, at least 75 wt. % water, at least 90 wt. % water, at least 95 wt. % water, at least 99 wt. % water. For example, the liquid can have a boiling point at 1 atm. of 180° C. In some embodiments, the wet filler has the consistency of a solid. As an option, a dry filler is wetted only to an extent such that the resulting wet filler maintains the form of a powder, particulates, pellet, cake, or paste, or similar consistency and/or has the appearance of a powder, particulates, pellet, cake, or paste. The wet filler does not flow like a liquid (at zero applied stress). As an option, the wet filler can maintain a shape at 25° C. when molded into such a shape, whether it be the individual particles, agglomerates, pellets, cakes, or pastes.

### EXAMPLES

The Examples demonstrate the use of a mixer equipped with a ventilation system as disclosed herein. Specifically, the mixer was a BB-16 tangential mixer (“BB-16”; Kobelco Kobe Steel Group) fitted with two 6-wing tangential rotors (type 6WI), providing 14.4 L capacity. The BB-16 was fitted with an inlet pipe 140 and an outlet pipe 150 as depicted in FIG. 1. A gas (air) was supplied to the ram space 120 through the inlet pipe and exiting the ram space through the outlet pipe. The mixer was further equipped with a variable speed fan that functioned as ventilator 180. A dust filter 160 was disposed between outlet pipe 150 and ventilator 180. The rate of air flow through the ram space was determined by two factors: (a) the cross-sectional area of the outlet pipe, Aₒᵤₜₗₑₜ (0.01824 m² based on 6″ diameter piping), and (b) velocity of the gas through the outlet pipe, Velocityₒᵤₜₗₑₜ (m/s), as controlled by the speed of the fan. The gas flowrate (Nm³/h) was calculated from the following equation as normalized for temperature (Tₒᵤₜₗₑₜ=temperature of outlet pipe):

$$Flowrate = ( {A}_{outlet} \times {Velocity}_{outlet} ) \times ( 273.15 K / ( 273.15 K + {T}_{outlet} ) ) \times 3600$$

Elastomer composites were prepared by mixing natural rubber, with wet carbon black filler or a blend of wet carbon black and wet precipitated silica in BB-16 mixer equipped with the ventilation system. For all mixing, the total filler content was targeted to loadings of 55 phr (carbon black only) and 50 phr (carbon black/silica blend). The wet carbon black filler was prepared by milling Propel® E7 carbon black (Cabot Corporation) and re-wetting in a pin pelletizer, resulting in moisture content of about 57%. Wet precipitated silica (ZEOSIL® 1165MP, Solvay USA Inc.) was also prepared in a pin pelletizer; however the dry precipitated silica filler was not milled prior to pelletization. The natural rubber used was standard grade natural rubber STR20 (Thailand). Technical descriptions of these natural rubbers are widely available, such as in Rubber World Magazine's Blue Book published by Lippincott and Peto, Inc. (Akron, Ohio, USA). The different formulations are listed in Table 1.

TABLE 1

| | | | Carbon | | Flowrate | Free |
|---|---|---|---|---|---|---|
| | NR | BR | Black | Silica | through ram | Water (%) |
| Example | (phr) | (phr) | (phr) | (phr) | space (Nm³/h) | *estimated |
| Ex. 1-1 | 100 | 0 | 56 | 0 | 469 | 4.44-8.88* |
| Ex. 1-2 | 100 | 0 | 56 | 0 | 572 | 4.43-8.87* |
| Ex. 1-3 | 100 | 0 | 56 | 0 | 662 | 0.87 |
| Ex. 1-4 | 100 | 0 | 56 | 0 | 746 | 0.00 |
| Ex. 1-5 | 100 | 0 | 56 | 0 | 812 | 0.00 |
| Ex. 1-6 | 100 | 0 | 56 | 0 | 1281 | 0.00 |
| Ex. 2-1 | 80 | 20 | 56 | 0 | 433 | 4.12 |
| Ex. 2-2 | 80 | 20 | 56 | 0 | 517 | 4.10 |
| Ex. 2-3 | 80 | 20 | 56 | 0 | 626 | 3.45 |
| Ex. 2-4 | 80 | 20 | 56 | 0 | 752 | 2.06 |
| Ex. 2-5 | 80 | 20 | 56 | 0 | 824 | 0.87 |
| Ex. 2-6 | 80 | 20 | 56 | 0 | 1221 | 0.00 |
| Ex. 3-1 | 100 | 0 | 36 | 15 | 445 | 0.00 |
| Ex. 3-2 | 100 | 0 | 36 | 15 | 692 | 0.00 |

The mixing was performed with power PID control after each addition of the filler. The proportional constant was 7.5%, the integral constant was 0.3 s, and no derivative control was used. The power set point varied between 50 kW to 90 kW depending on the mixing step and the maximum output of the power PID control loop was set to 100 rpm. The power input signal used by the power PID control loop was filtered by using a Kalman filter with a K2 constant of 0.005 (see Appendix 1). The control system performed these calculations approximately every 0.2 s. First stage conditions were: TCU temperature=90° C.; fill factor=66%; ram pressure=120 psig. The mixing protocol is shown in Table 2.

TABLE 2

| | | Time | Temp | Ram | | Power Set | rpm | rpm |
|---|---|---|---|---|---|---|---|---|
| Step | Description | (s) | (° C.) | Position | Rpm | Point | (min) | (max) |
| 1 | Add 50% Polymer - 75% | — | — | Up | 40 | | — | — |
| | Filler - then remaining | | | | | | | |
| | 50% Polymer | | | | | | | |
| 2 | Masticate to target | 20 | | Down | 40 | | — | — |
| | time or temperature | | | | | | | |
| 3 | Mix under power PID | | * | Down | Power | 90 | 50 | 100 |
| | control until 125° C. | | | | PID | | | |
| 4 | Speed Reduction | 10 | — | Up | 20 | | — | — |
| 5 | Add remaining | 20 | — | Up | 20 | | — | — |
| | 25% Filler | | | | | | | |
| 6 | Mastication under | 20 | | Down | Power | 50 | 40 | 60 |
| | PID control | | | | PID | | | |
| 7 | Mix under power PID | | ** | Down | Power | 60 | 40 | 100 |
| | control until stated | | | | PID | | | |
| | temperature | | | | | | | |
| 8 | Mix under power PID | | *** | Down | Power | 90 | 50 | 100 |
| | control until stated | | | | PID | | | |
| | temperature | | | | | | | |
| 9 | Discharge Mixer & | 15 | — | Floating | 20 | | — | — |
| | close Drop Door | | | | | | | |

*130° C. for Ex. 1; 125° C. for Ex. 2; 145° C. for Ex. 3
**125° C. for Ex. 1 and Ex. 2; 135° C. for Ex. 3
***150° C. for Ex. 1; 145° C. for Ex. 2; 137° C. for Ex. 3

After the composite was discharged, any free water discharged was collected along with the discharged composite. Free water was filtered out and weighed to determine the amount of free water as a function of the ventilation flowrate. In some cases, free water remained in the ram space and the amount of free water was estimated. The results are shown in Table 1, in which the amount of free water is reported relative to the total weight of the composite.

In general, it can be seen that increasing the flowrate of gas through the ram space decreases the amount of free water discharged or remaining in the ram space. No free water was observed when the filler included silica over the gas flowrates evaluated. Without wishing to be bound by any theory, the gas flowrate for silica-containing fillers can be decreased due to the hygroscopic nature of silica, which allows for a more gradual release of the water. These examples demonstrate that enabling a flow of gas through the ram space can result in a relatively dry elastomer composite in a first stage mix (or single stage mix) when mixing elastomer and filler in the presence of a liquid (e.g., wet filler).

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This Specification and the embodiments described are exemplary only, with the true scope and spirit of the disclosure being indicated by the claims that follow.

### Appendix 1: Kalman Filter Description

Variables:
P=process variable (to be filtered by control system)
E=filtered estimate of P
(calculated by the control system for each time increment of x)
R=rate of change of P with time
(calculated by control system for each time increment of x)
t=time
x=increment of time used by control system (for data input, calculations and data output)
K2=filter constant input by user into control system
K1=filter constant calculated from K2

### Working Equations:

$$K 1 = 2 ( K 2 ) ** 0.5 - K 2$$

$$Et = Et - x + Rt - x + K 1 ( Pt - Et - x - Rt - x )$$

$$Rt = Rt - x + K 2 ( Pt - Et )$$

Notes:
Initial estimates of E and R have to be made (values of 0 are often acceptable).
K2 is empirically selected by user to obtain the desired filtering of P.

1. A method of preparing an elastomer composite, comprising:
(a) charging a mixing chamber of a batch elastomer mixer with at least an elastomer and a filler through a ram enclosure;
(b) mixing the elastomer and the filler in the mixing chamber, which includes:
(i) rotating one or more rotors disposed in the mixing chamber,
(ii) moving a ram through a ram space towards the mixing chamber to push the elastomer and the filler in the ram enclosure downwards into the mixing chamber, the ram space defined by the ram enclosure, and
(iii) directing a flow of gas through the ram space from a vent inlet to a vent outlet disposed in the ram enclosure, the flow of gas passing through the ram space and entraining at least a portion of a vapor resulting from the mixing; and
(c) discharging the elastomer composite from the mixing chamber.

2. The method of claim 1, wherein a minimum flowrate of the flow of gas through the ram space is at least 200 Nm³/h.

3-4. (canceled)

5. The method of claim 1, wherein the flowrate is an average flowrate.

6. The method of claim 1, wherein the flow of gas is continuous.

7. The method of claim 1, wherein the flow of gas is pulsed.

8. The method of claim 1, further comprising a ventilator in gaseous communication with the mixer, the ventilator being configured to direct the gas to flow from the vent inlet to the vent outlet from the ram space via the vent outlet.

9. The method of claim 8, wherein the ventilator is selected from a fan, a blower, a gas pump, compressor, an eductor, and a venturi.

10. The method of claim 8, wherein the ventilator is disposed at one or more of the vent inlet and the vent outlet.

11. The method of claim 8, wherein the ventilator is disposed at the vent outlet and is configured to suction the gas from the ram space into the vent outlet.

12. The method of claim 8, during the mixing, further comprising a controller configured to:
detect, via a pressure sensor, a pressure of the ram space, and
control the ventilator so that the pressure of the ram space is at the negative pressure.

13. The method of claim 12, wherein the controller is configured to adjust a flow of the gas directed by the ventilator so as to maintain the ram space at the negative pressure.

14. The method of claim 12, wherein the controller is configured to adjust a flow of the gas directed by the ventilator based on mixer power.

15. (canceled)

16. The method of claim 1, further comprising selectively opening one or more of the vent inlet and the vent outlet.

17. The method of claim 1, further comprising opening one or more of the vent inlet and the vent outlet during a mixing operation and closing one or more of the vent inlet and the vent outlet during the charging.

18. The method of claim 1, further comprising blocking the vent outlet with a gate for the vent outlet while the ram is vertically disposed at or above the vent outlet

19. The method of claim 1, wherein the vent inlet and the vent outlet are disposed on opposite side walls of the ram enclosure.

20. The method of claim 1, wherein the vent inlet and the vent outlet are disposed side-by-side on a wall forming the ram enclosure.

21. The method of claim 1, wherein:
the vent inlet and the vent outlet are located in an upper portion of the ram enclosure;
the vent inlet and the vent outlet are located in a lower portion of the ram enclosure;
the vent inlet is located in an upper portion of the ram housing and the vent outlet is located in a lower portion of the ram enclosure; or
the vent inlet is located in a lower portion of the ram housing and the vent outlet is located in an upper portion of the ram enclosure.

22-23. (canceled)

24. The method of claim 1, wherein the charging comprises charging the solid elastomer and filler through a feed hopper door disposed in the ram enclosure, and wherein the vent inlet is disposed above the feed hopper door.

25. (canceled)

26. The method of claim 24, wherein the ram enclosure includes a rear wall opposite the feed hopper door, the vent outlet being disposed in the rear wall of the ram enclosure.

27. The method of claim 26, wherein the vent inlet is disposed in the rear wall of the ram enclosure.

28. The method of claim 1, further comprising removing airborne particulates from the ram enclosure with a hood disposed above one or more of the vent inlet and the vent outlet.

29. The method of claim 1, further comprising a filter or scrubber disposed intermediate the vent outlet and the ventilator.

30. (canceled)

31. The method of claim 1, wherein the batch elastomer mixer further comprises a vent outlet passageway extending from the vent outlet.

32. The method of claim 31, wherein the vent outlet passageway extends at an upward angle from the vent outlet.

33. The method of claim 1, wherein the batch elastomer mixer further comprises a vent inlet passageway extending from the vent inlet.

34. The method of claim 1, further comprising an additional vent inlet in the form of a high-pressure gas line.

35. The method of claim 1, wherein the mixing chamber further comprises an additional vent outlet in the form of a vent plunger disposed on the mixing chamber to provide additional ventilation.

36-37. (canceled)

38. The method of claim 1, wherein the filler is a wet filler comprising a liquid, at least a portion of which is evaporated during the mixing to generate the vapor.

39. The method of claim 1, wherein the charging in (a) further comprises charging the mixer at least one coupling agent.

40. The method of claim 1, wherein the charging of filler in (a) comprises charging the mixer with the filler contained in low melt bags.
